(19) United States
(12) Patent Application Publication
(10) Pub. No.: US 2002/0072815 A1
(43) Pub. Date: Jun. 13, 2002

(54) Portable information system and method for golf play enhancement, analysis, and scorekeeping

(76) Inventors: William A. McDonough, Clemmons, NC (US); Eric Stockburger, Winston Salem, NC (US)

Correspondence Address: Richard C. Litman, LITMAN LAW OFFICES, LTD., P. O. Box 15035, Arlington, VA, 22215, US

(21) Appl. No.: 09/734,644

(22) Filed: Dec. 13, 2000

Related U.S. Application Data
(60) Provisional application No. 60/177,276, filed on Jan. 21, 2000.

(51) Int. Cl. G06F 155/00

(52) U.S. Cl. 700/92

(57) ABSTRACT

A portable information system for golf. A hand-held computer (or, alternatively, a palm device) is used for providing a portable computer processing means to be carried by a golfer while playing a game of golf. A first software program (referred to as a Virtual Caddie™) is programmed in the hand-held computer for providing a virtual caddie to provide information regarding a particular golf course and a particular player's golf game, to track player performances, and to communicate a player's competitive match detail to other players. A macro stored on the hand-held computer (or palm device) is used for providing access to a virtual golf country club program residing on web servers for providing a golfer a means to evaluate his or her golf performance. A receiver means is selectively communicatively connected to the hand-held computer for enabling the hand-held computer to receive GPS and DGPS coordinate positions corresponding to a location on a golf course. A user interface is communicatively connected to the portable for enabling the golfer to interact with the hand-held computer.

### CROSS-REFERENCE TO RELATED APPLICATION

This application claims the benefit of U.S. Provisional Patent Application Serial No. 60/177,276, filed Jan. 21, 2000.

### BACKGROUND OF THE INVENTION

1. Field of the Invention

The present invention relates generally to computer type electronic devices to assist in playing the game of golf and, in particular, to a portable information system and method for enhancing golf.

2. Description of Related Art

It is important in the game of golf to be able to accurately judge the distance to the hole. Knowing this distance enables the player to choose the appropriate club. Two frequently encountered problems that degrade a golfer's performance are: (i) inaccurate knowledge of the pertinent distance, and (ii) lack information about the golfer's own past performance in a similar circumstance. As a result of either or both of these circumstances, the golfer will frequently over-club or under-club the shot.

In contrast with other sports, proper club selection rather than the amount of force applied plays a critically important role in proper ranging on the golf course. In other words, a properly taught golfer swings consistently and uniformly, varying the distance principally by proper club selection, and only occasionally by utilizing a shortened swing.

Also a problem exists with respect to compensating for other environmental conditions, such as wind and temperature, and also, the particular pin and tee placement in effect on any given golf course on any given day. Finally, many other factors complicate the process of golfing. For example, wagering or betting may accompany golfing, thereby creating distractions that can degrade performance. Also, such wagering or betting can even lead to disputes with fellow golfers if not properly accounted for-thus accounting for even more degradation in the play of golf. Also, during tournament play, the audience who is only able to view one hole at a time may wish to track a particular golfer's performance by looking at a scoreboard that is automatically updated on shot-by-shot basis, so that results can be known even before the golfer completes the round. This is particularly important in those competitive golfing events where the honor system is employed, and score keepers do not monitor the play of golf.

Also, the performance of opponents (either within or not within a golfer's own foursome) can create pressure. For example, in tournament play, if an adversary has already finished a round of golf, a particular golfer may need to perform at a certain predetermined level in order to win. Also, golfers often become forgetful about past performance on the golf course-not able to remember how their own best previous results were obtained. For example, a golfer may not be able to recall what club produced favorable results in similar or identical circumstances now presented to that golfer. Also, during practice sessions, golfers need to know what shots are their weakest, so that they know what to emphasize during practice.

A variety of devices for assisting a player's performance on a golf course appear in the prior art. These generally include range-finder type devices which are capable of measuring, with varying degrees of accuracy, the distance to a given object, such as a flag pole or “pin.” These “visible rangefinding” devices typically require that the flag pole or pin be visible to the golfer from the current position of the ball. Thus, they are not effective if the flag pole or pin is not visible.

Other prior art rangefinding devices utilize the flag pole or pin as a reflector of, or receiver for, electromagnetic signals. For example, the flag pole might be used to reflect or repeat a signal pulse.

Still other prior art rangefinding devices require that golfers consult course maps and make “on the spot” distance calculations-many of which are complicated and imprecise.

Many other prior art devices include expensive and complex devices which utilize sensors which are installed beneath the fairway turf. For example, by installing such sensors at ten yard intervals, a golf cart can be outfitted with a device to track its position in relation to the features of a golf course. Such a method is costly, particularly due to the environmental conditions that the buried equipment is exposed to, given the fact that people and vehicles are constantly passing over them. Also, various portable devices are available to record, manipulate, and display golfer performance information, however, these devices do not provide any distance tracking capability, and are only responsive to number of shots taken, and so forth.

Below are several patents that are illustrative of known computer devices for enhancing the game of golf. U.S. Pat. No. 5,283,733 issued on Feb. 1, 1994 to Russell H. Colley describes a computer network that extends around all holes of a golf course including a series of interconnected display terminals that can display the real scores of all players on the course at any time.

U.S. Pat. No. 5,364,093 issued on Nov. 15, 1994 to Charles D. Huston et al. describes a method and system for determining the approximate distance from a golf ball to the golf cup on the golf green. The system stores the location of the golf cup in computer memory and determines the location of a global positioning satellite receiver positioned near the golf ball. The system calculates the distance between the golf cup location and the receiver location.

U.S. Pat. No. 5,507,485 issued on Apr. 16, 1996 to Donald Fisher describes a portable computer to facilitate the game of golf. The computer is programmed to record a golfer's score and keep track of various shots and the results of related wagering. Based upon such data and data regarding the layout of the golf course, the computer can provide real time recommendations for club selection as well as providing a summary of the results of a round of golf. Also, the computer can receive global positioning system (GPS) signals to locate a golf ball within a golf course.

U.S. Pat. No. 5,524,081 issued on Jun. 4, 1996 to Benjamin J. Paul describes a golf information and management system utilizing the Global Positioning System, a satellite based, radio navigation system where clock signals are transmitted.

U.S. Pat. No. 5,685,786 issued on Nov. 11, 1996 to Douglas P. Dudley describes a golf information system and method which provides yardage and other information to a golfer relative to landmarks on a golf course operating in a “hands-free” or passive manner.

U.S. Pat. No. 5,689,431 issued on Nov. 18, 1997 to Richard W. Rudow et al. describes a player position determining and course management system for a golf course having a plurality of roving units for use by players in playing the course.

U.S. Pat. No. 5,767,795 issued on Jun. 16, 1998 to Richard A. Schaphorst describes an electronic tour guide that overcomes the monotony of an automobile trip.

U.S. Pat. No. 5,772,534 issued on Jun. 30, 1998 to Douglas P. Dudley describes a golf information system which provides for automatic detection of a golf cart position on a golf course by either a golfer on the cart or personnel in a golf course clubhouse. In one embodiment, a differential global positioning satellite receiver (DGPS) is utilized to detect a golf cart position and where it is further transmitted to a golf cart display as well as to a clubhouse display, either automatically in a timed manner, or upon prompting by a golfer or clubhouse personnel.

U.S. Pat. No. 5,938,721 issued on Aug. 17, 1999 to William O. Dussel et al. describes a position based personal digital assistant. A task description is stored in a database accessible by a mobile computer system. The mobile computer system receives positioning information corresponding to its geographic location and indexes the database based on the positioning information facilitates completion of a task associated with the task description.

Japanese Pat. No. 392,022 issued on Apr. 17, 1991 describes a radio golf score system.

While the aforementioned references describe a variety of portable golf computer devices, none of these references disclose a portable information system that includes a GPS and DGPS for enhancing the sport of golf. Moreover, none of the aforementioned references disclose a portable information system for golf that is capable of permitting player to player communications. None of the aforementioned references disclose a portable information system for golf that is capable of calculating distances between any two point on a golf course.

None of the above inventions and patents, taken either singly or in combination, is seen to describe the instant invention as claimed.

### SUMMARY OF THE INVENTION

A portable information system for golf. A hand-held computer is used for providing a portable computer processing means to be carried by a golfer while playing a game of golf. A first software program (referred to as a Virtual Caddie™) is programmed in the hand-held computer for providing a virtual caddie to provide information regarding a particular golf course and a particular player's golf game, and to track player performances. A means to access a second software program and set of internet pages and applications (referred to as a virtual golf country club program) is also programmed in the hand-held computer for providing a golfer a means to review and evaluate his or her golf performance. A receiver means is selectively communicatively connected to the hand-held computer for enabling the hand-held computer to receive transmitted GPS and DGPS signals for identifying a coordinate position corresponding to a location on a golf course. An input means is communicatively connected to the portable device for enabling the golfer to interact with the hand-held computer.

Accordingly, it is a principal object of the invention to provide a portable information system that includes a GPS and DGPS receiver for enhancing golf.

It is another object of the invention to provide a portable information system for golf that is capable of providing player to player communications.

It is a further object of the invention to a portable information system for golf that is capable of calculating distances between any two points on a golf course.

Still another object of the invention is to provide a portable information system for golf that has a computer processing means that can be voice activated.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a block diagram of a portable information system for golf according to a preferred embodiment of the present invention.

FIG. 2 is an illustration of a hand-held PC according to a preferred embodiment of the present invention.

FIG. 3 is a plan view of the top of a receiver cradle according to a preferred embodiment of the present invention.

FIG. 4 is a plan view of the bottom of the receiver cradle according to a preferred embodiment of the present invention.

FIG. 5 is an elevation view of the receiver cradle.

FIG. 6 is a plan view of the top of an RS-232 adapter according to a preferred embodiment of the present invention.

FIG. 7 is a plan view of a palm device according to a preferred embodiment of the present invention.

FIG. 8 is a plan view of the palm device inserted into the RS-232 adapter.

FIG. 9 is a plan view of the receiver cradle having the palm device and RS-232 adapter inserted therein.

FIG. 10 is an illustration of the hand-held PC and palm device connected to a set of conventional phone jacks.

FIG. 11 is an illustration of the hand-held PC and palm device connected to a desk top PC.

FIG. 12 is an illustration of a first window for enabling a computer user to specify a golf course selection.

FIG. 13 is an illustration of a second window for enabling a computer user to enter personal information.

FIG. 14 is an illustration of a third window for enabling a computer user to edit information retrieved from a database.

FIG. 15 is an illustration of a fourth window for viewing a golf course configuration for a particular hole.

FIG. 16 is an illustration of a fifth window for displaying the distance between two points on a golf course.

FIG. 17 is an illustration of a sixth window for selecting a club and for designating the lie of a golf ball.

FIG. 18 is an illustration of a seventh window for listing a player's statistics for each club.

FIG. 19 is an illustration of a eighth window for selecting a spin for a ball.

FIG. 20 is an illustration of a ninth window for displaying a ball marking in real time.

FIG. 21 is an illustration of a tenth window for marking a pin and ball for accuracy.

FIG. 22 is an illustration of an eleventh window for displaying a final score for a hole.

FIG. 23 is an illustration of a twelfth window for displaying a final score and enabling a playing a player to share a score.

FIGS. 24 A-C show a flow chart of a preferred information process for enhancing the play of golf by an individual.

FIGS. 25 A-G show illustrations of a plurality of player statistical charts according to the present invention.

FIG. 26 is an illustration of a thirteenth window for displaying a player's history of golf shots over a geocoded bitmap.

Similar reference characters denote corresponding features consistently throughout the attached drawings.

### DETAILED DESCRIPTION OF THE PREFERRED EMBODIMENTS

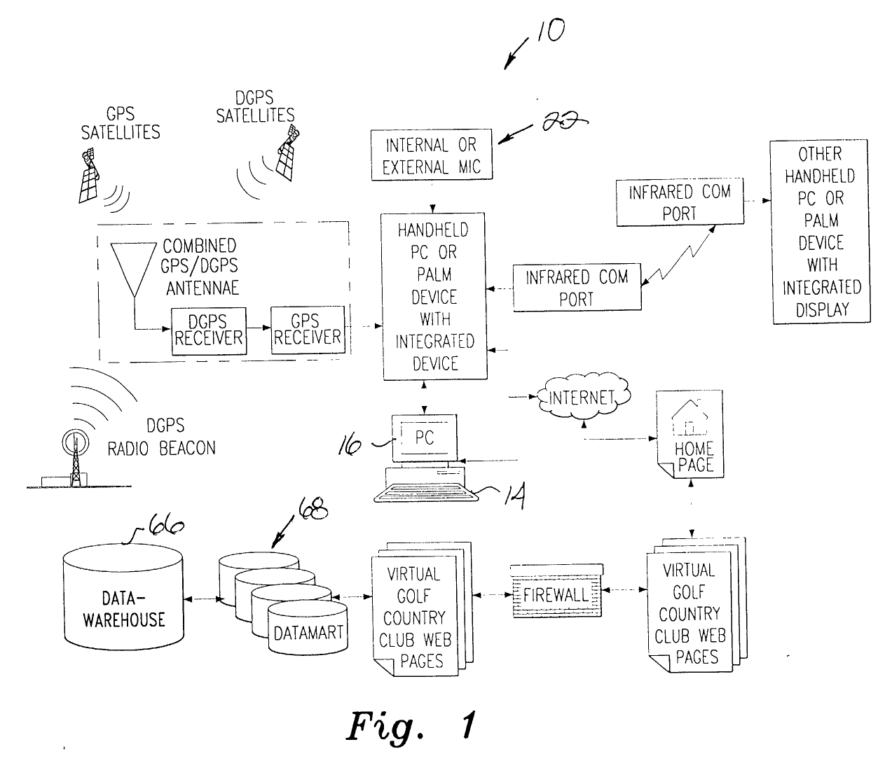

The present invention is a portable information system for enhancing the sport of golf. A portable information system 10 according to a preferred embodiment of the present invention is shown in FIG. 1. A golf software program (hereinafter referred to as the golf program) (a.k.a., the Virtual Caddie™) is preferably stored in a hand-held computer 12 for providing a virtual caddie to provide information regarding a particular golf course and particular player's golf game, to track players' performances, and to communicate a player's competitive match detail to other players. Alternatively, the golf program may be stored on a palm device 13 described later in this application. A conventional macro stored on the hand-held computer 12 or desktop personal computer 16 is preferably used for providing access to a virtual golf country club program that resides on conventional Web servers. Together, the macro and virtual golf country club program may be used for enabling a golfer to review and evaluate his or her golf performance. The virtual golf country club program also provides access to golf-related services.

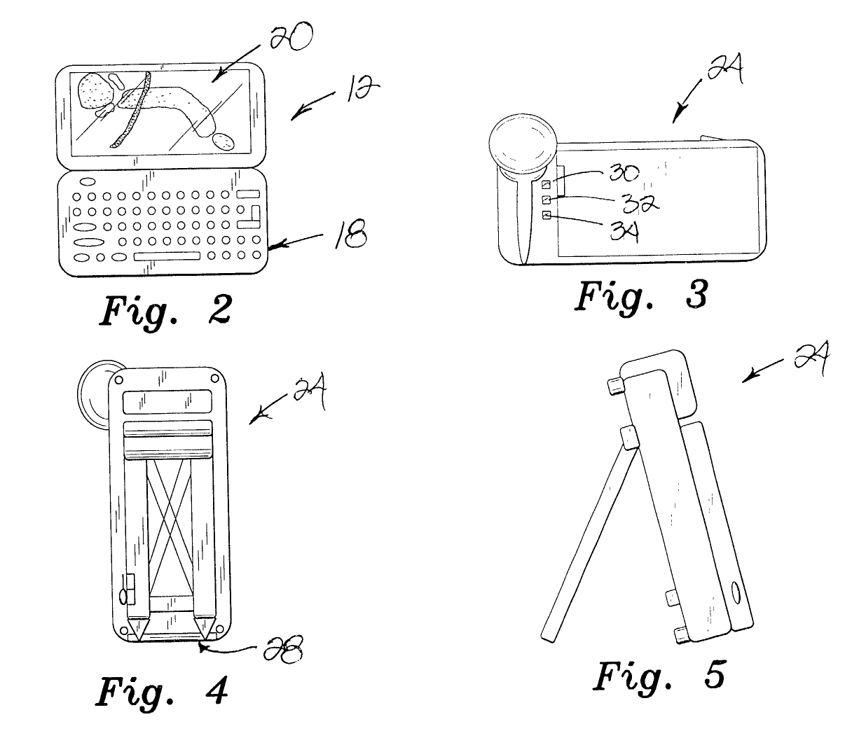

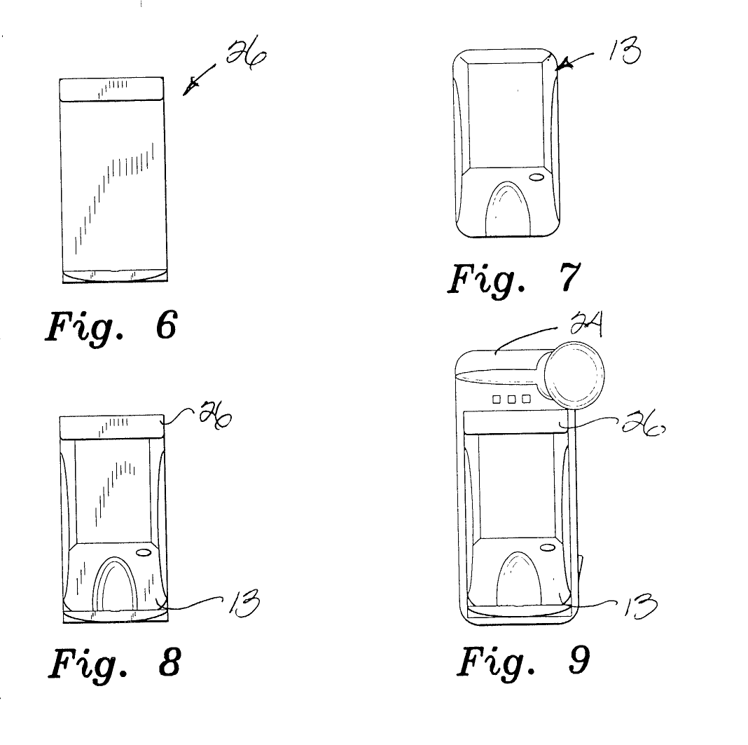

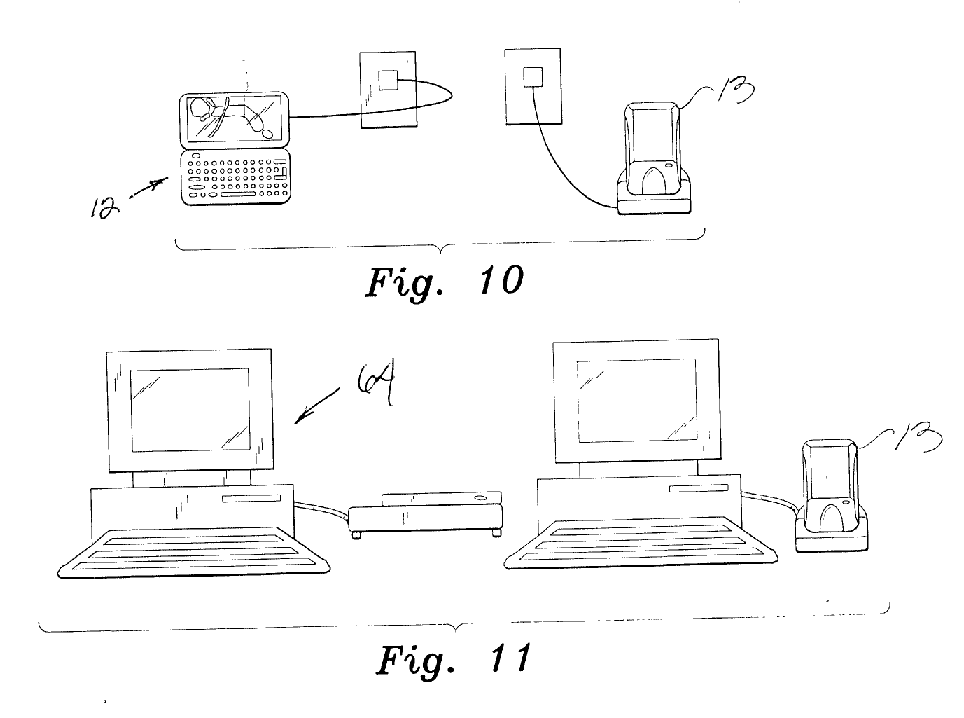

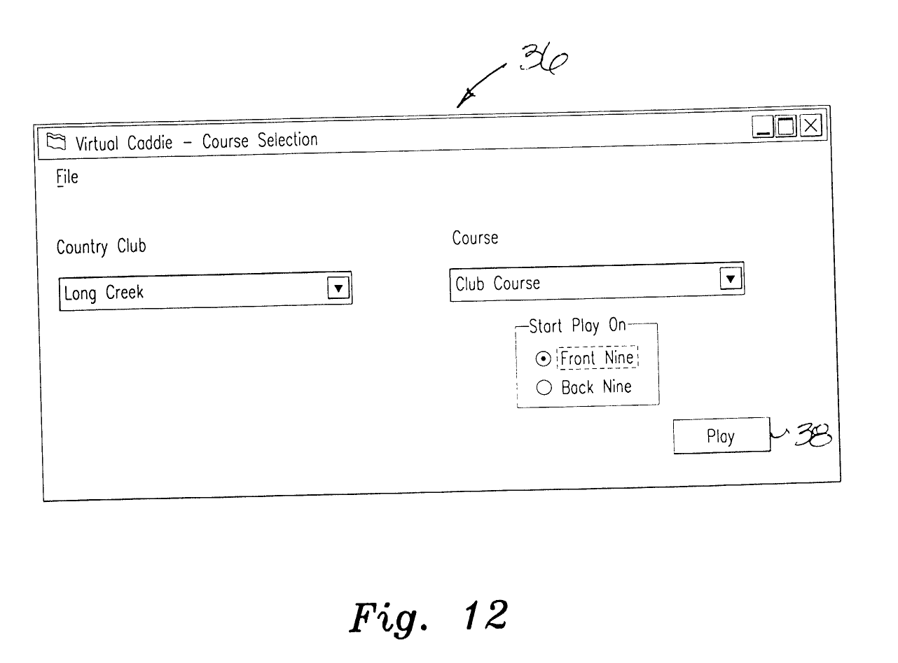

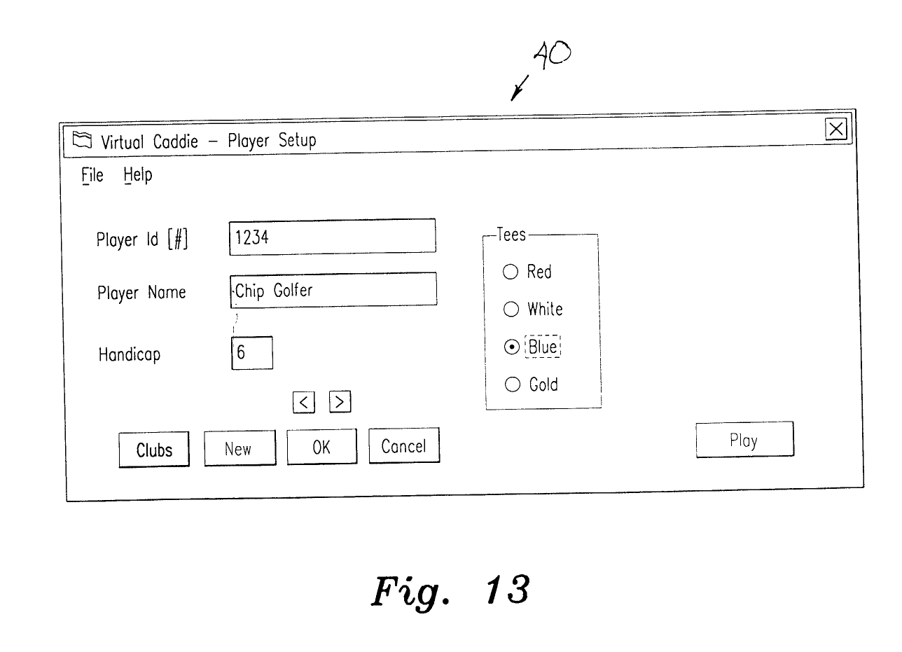

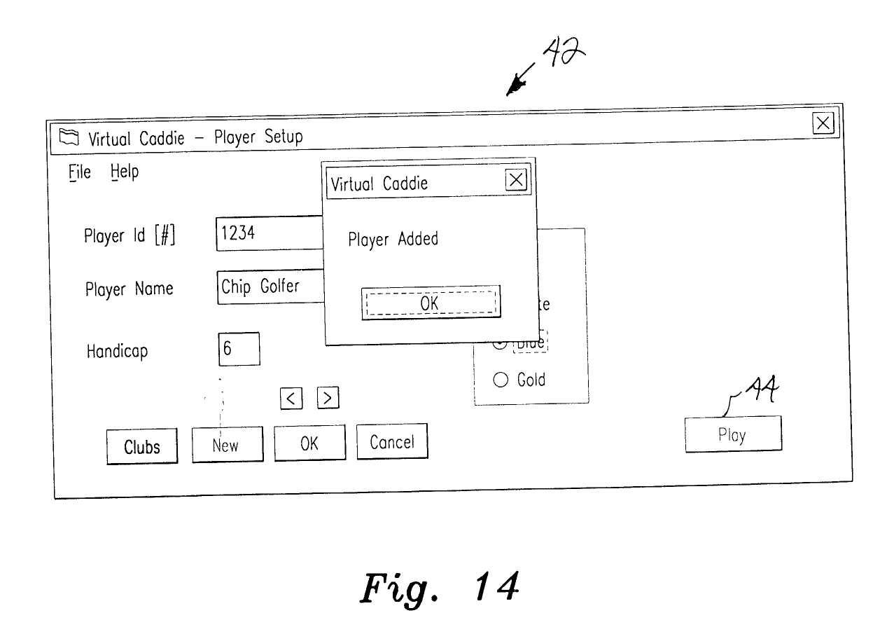

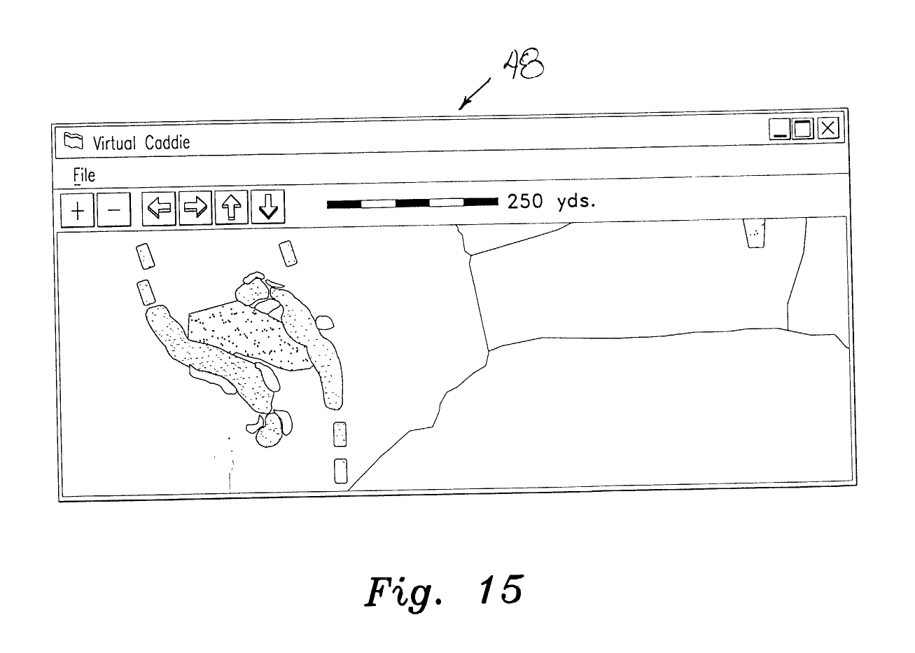

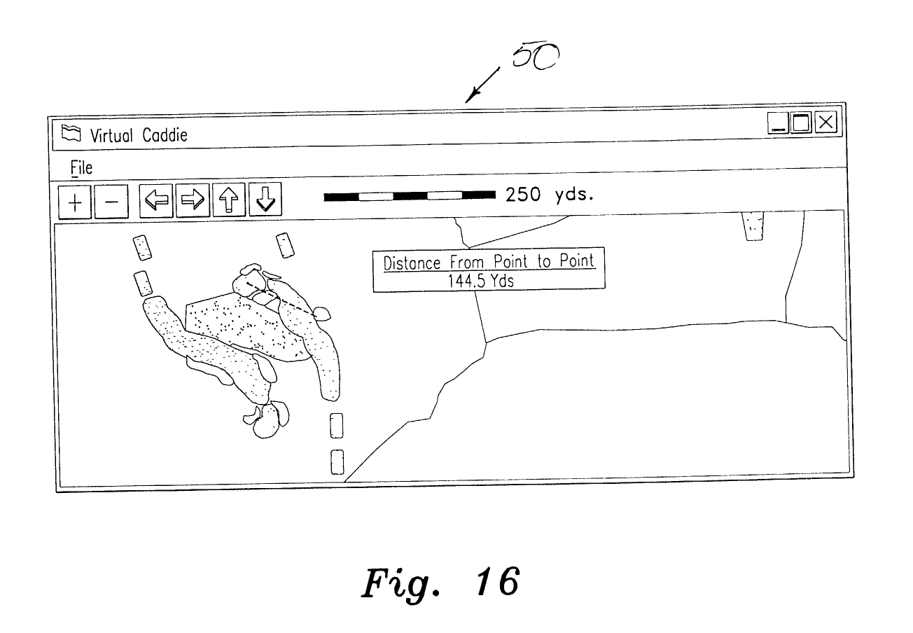

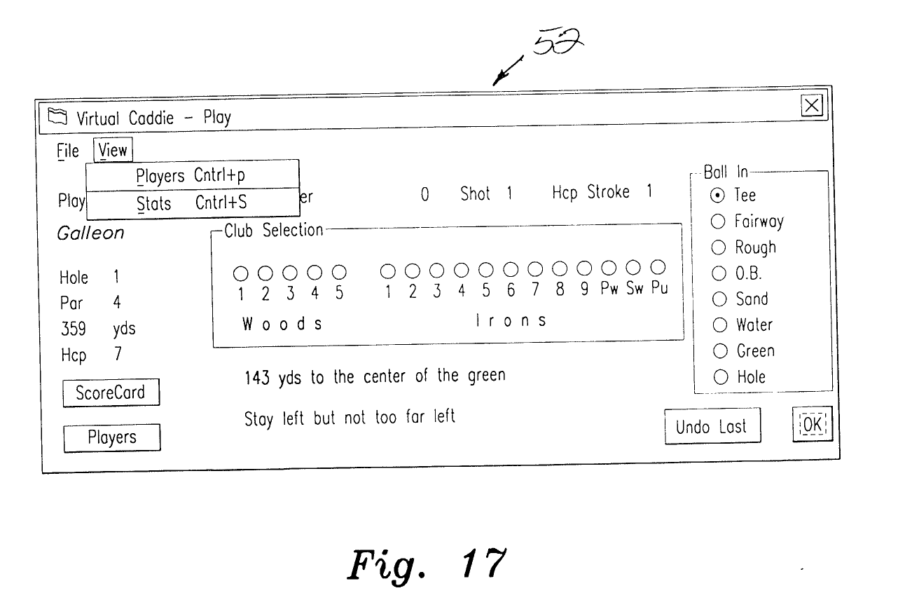

A keyboard, a touch screen, or a voice recognition interface may be used to interact with the golf program. Illustrations of these components are contained in FIGS. 1 and 2. The keyboard may be in the form of a conventional keyboard 14 communicatively connected to a conventional personal computer 16, or the keyboard may be in the form of a keypad 18 contained on the hand-held computer 12.

A touch screen 20 is shown in FIG. 2 according to a preferred embodiment of the invention. As depicted, the touch screen 20 is a display screen contained in the hand-held computer 12. According to the present invention, only the display screen of the hand-held computer 12 is designed to function as a touch screen.

A voice recognition interface 22 is represented in FIG. 1 as an internal or external microphone communicatively connected to the hand-held computer 12. Accordingly, a player may use voice commands to initiate various functions of the golf program.

A combined GPS and DGPS receiver cradle (hereinafter referred to as the receiver cradle) 24 may be used for holding the hand-held computer 12. The cradle is configured with a conventional RS-232 serial port to be communicatively connected to the hand-held computer 12 when the hand-held computer 12 is inserted in the receiver cradle 24 for enabling a GPS and DGPS coordinate position to be transmitted in real time to the golf program.

Next, further details relating to a preferred method for using the portable information system 10 is described. Individual golfers may use the portable information system 10 to collect data about their respective golf games as each player plays a round of golf. The portable information system 10 acts as a virtual caddie by providing golf course information (e.g., hole number, yardage, par, handicap, course views, distance between two points on a golf course, play tips, etc), personal assessment and statistical detail (e.g., average club distances, accuracy statistics, scoring information, etc.). The golfer may carry the hand-held computer 12 with or without an attached receiver cradle 24 as a round of golf is played. The hand-held computer 12 runs the golf program interactively with the receiver cradle 24 to enhance the play of golf. Prior to a round of golf, a golfer may download personal history, a course map, and other related details (from the Virtual Golf Country Club program) onto the hand-held computer 12. At the discretion of each golfer, a golfer may input information into the hand-held computer 12 during a round a golf. Each golfer may also exchange information with other players using conventional wireless communication devices (e.g., infrared, cellular, or internet communication devices). When a round is completed, a golfer may upload data to the virtual golf club and secure the data in a personal Members Lockers^{SM}, where updated stats, graphs, teaching tips, and replays of prior rounds may be obtained. If the golfer intends to play another round of golf at another course, he or she may download additional golf course maps and related details.

When a golfer carries the palm device 13, the golfer may snap on and use an adapter 26 to convert serial connection contacts of the palm device 13 to an RS-232 connector. The golfer may then slide the adapter 26 into the receiver cradle 24. Once connected, the golfer may slide a conventional rechargeable battery (not shown) into a battery compartment 28 of the receiver cradle 24. Once the receiver cradle 24 acquires a necessary number of GPS satellites, a first green light 30 will illuminate. As a DGPS signal is received, a second green light 32 will illuminate. If any of the GPS and DGPS signals are lost, the corresponding lights will go out. If the rechargeable battery (not shown) runs low, a battery indicator source light 34 will illuminate, prompting a golfer to change the rechargeable battery. The golfer will also be able to check the status of the receiver cradle 24 and the rechargeable battery (not shown) from the program running on the hand-held computer 12.

Using the portable information system during a golf game. Prior to approaching the first golf tee, a golfer must select a club, a particular course, and either the front or back nine holes of the course by entering the applicable information in a first window 36, shown in FIG. 12. Upon entering all applicable information in the first window 36, the golfer must select a Play button 38 to advance to a second window 40 (hereinafter referred to as the Player Setup window), shown in FIG. 13. The Player Setup window 40 may then be used to enter his or her name, handicap, clubs, and tee being played. Thereafter, this information is preferably recalled from a database as default settings and edited, if desired, using a third window 42 during each round of play. FIG. 14 is an illustration of the third window 42 after some of the recalled information has been edited to enable the golfer to confirm the set up information. Upon confirmation of the recalled information, the golfer may press a play button 44 to advance the golf program to a fourth window 46 (hereinafter referred to as the main game window), shown in FIG. 19.

A fifth window 48 may be used for enabling a golfer to review details relating to a particular hole on a golf course and to open a map of a particular hole of a golf course (see FIG. 15). A sixth window 50 may be used for enabling a golfer to obtain information regarding a distance to the next pin from any point on a golf course (see FIG. 16). A seventh window 52 and eighth window 54, shown respectively in FIGS. 17 and 18, may be used for enabling a golfer to review his or her personal golfing statistics to aid in club selection. According to a preferred embodiment, a golfer may hold the hand-held computer 12 over the spot where a previous shot was taken and select the club that was used, the lie, the spin, and the strength of contact of the shot using a fourth window 46. After selecting this information, the golfer may proceed to a next shot by pressing an OK button 56 or may re-enter any information selected in error by pressing an Undo Last button 58.

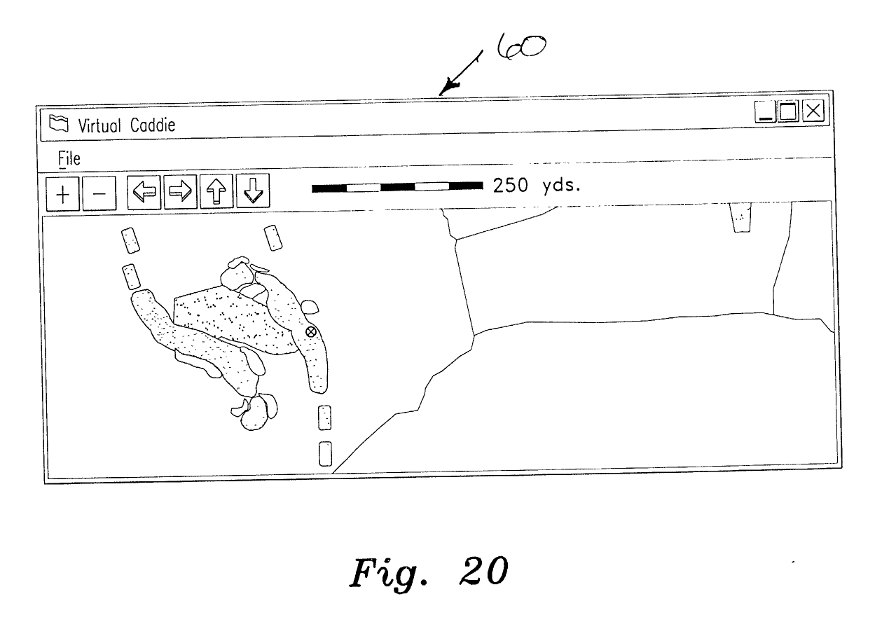

Upon execution of an ok command, the golf program automatically captures an exact GPS coordinate position and stores the coordinate position with information relating to the last shot. For a non-GPS/DGPS enabled version, a player may go to a ninth window 60 (hereinafter referred to as a course map window), such as is shown in FIG. 20, and mark the position of the ball as each shot is completed. Accordingly, the golf program is able to capture the approximate coordinate position of a golf ball and store this information with the applicable golf shot information. The golf program then preferably advances to a next shot automatically and waits for an input from the golfer. According to the present invention, the golf program is designed to automatically allocate appropriate stroke penalties in accordance to official rules of golf for a variety of situations, such as a golf ball hit out of bounds, a lost golf ball, and an unplayable lie.

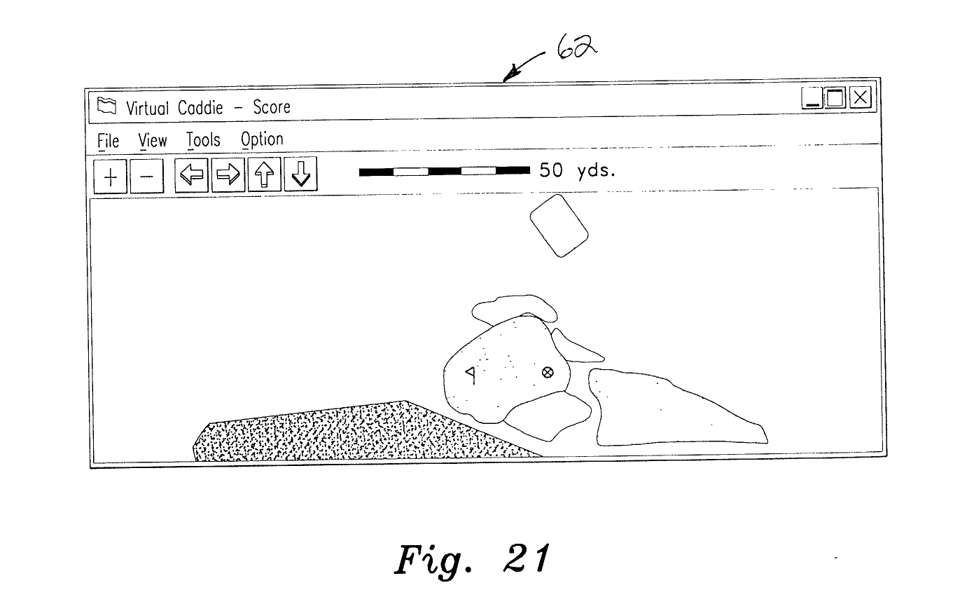

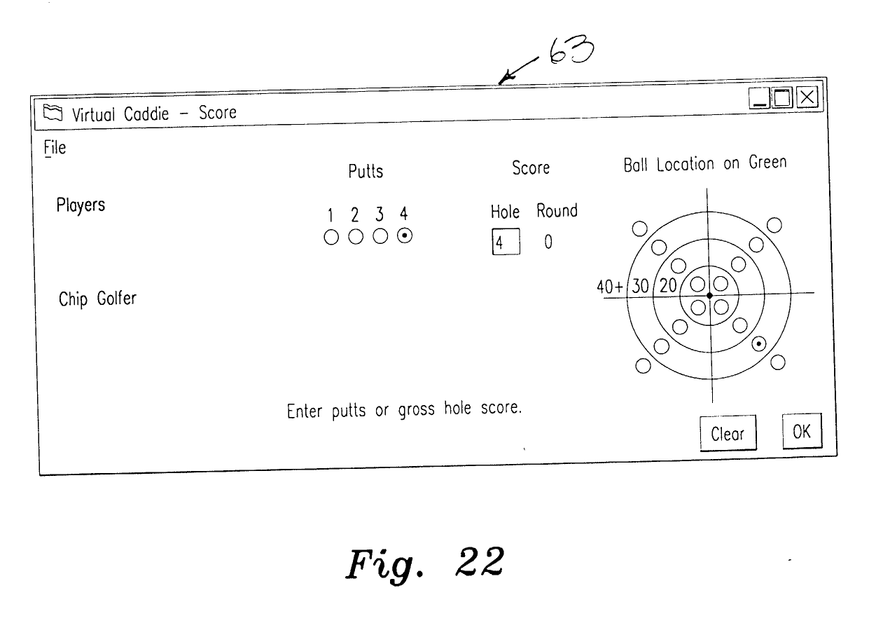

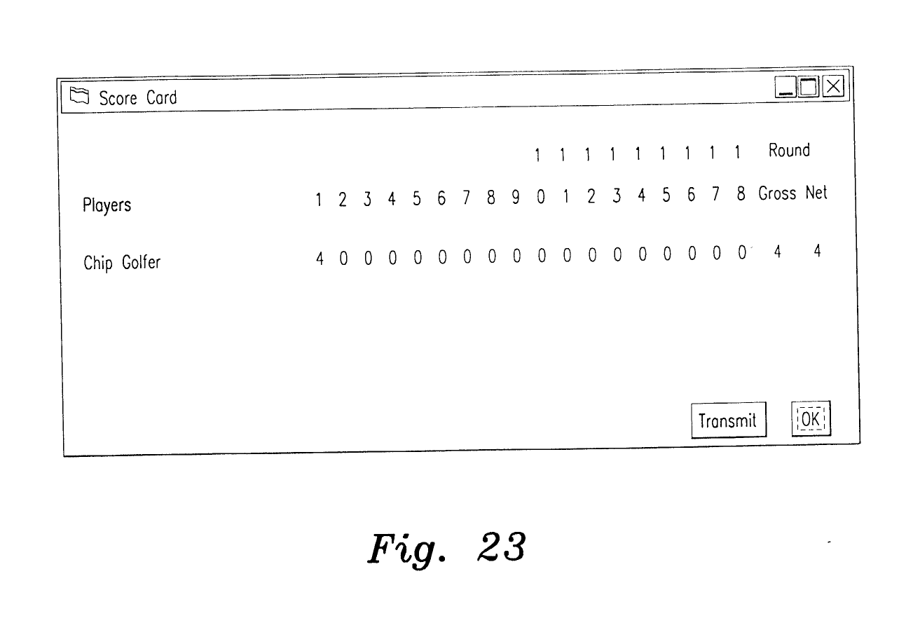

As illustrated in FIG. 21, the golf program will display a golfer's pin accuracy and final score in a tenth window 62 once the golfer inputs the lie of a golf ball as the green. With a GPS and DGPS-enabled version of the portable information system 10, the golfer will step up to the pin and “mark” the pin location. The golfer will then return to the location of his or her golf ball and mark that location. Upon sinking a putt, the golfer will input the total number of putts or final score. See FIG. 22. In the non-GPS/DGPS enabled version of the golf program, the golfer would input the accuracy of an approach shot relative to the pin using the “bullseye” target input and then enter the number of putts or the final score in an eleventh window 63, shown in FIG. 22. When the golfer completes this input of information, the golfer can transmit their scoring detail to other players using the system to track competitive match play information and the golf program will advance to the next hole and will update an on board database and scorecard. The golfer will continue with this process until completion of a golf game or a current round.

Upon completion of a round of golf, the golfer preferably will remove the hand-held computer 12 from the receiver cradle 24 and will upload his or her data via one of two methods:

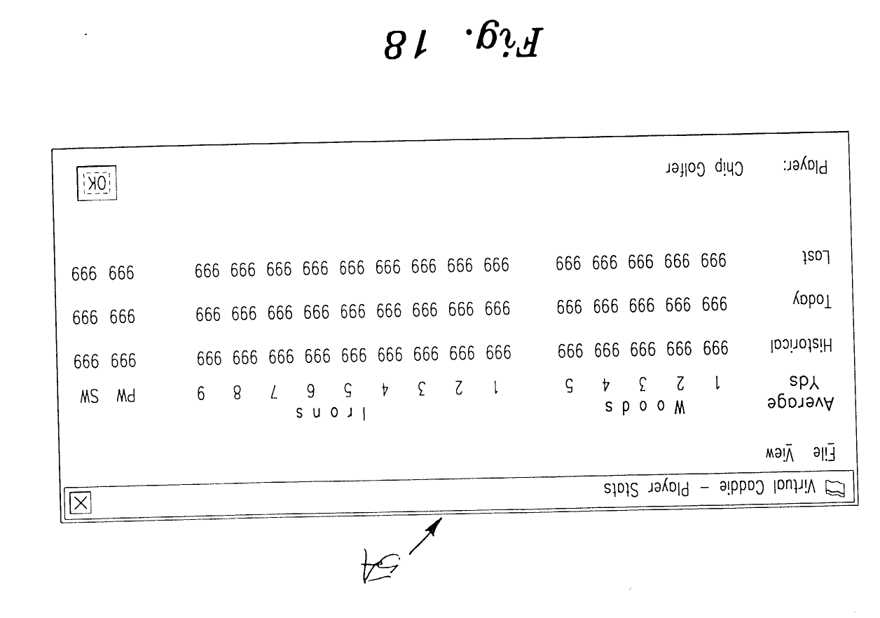

1. directly connecting the hand-held computer 12 to an internet website using a conventional internal modem connection and phone jack, as illustrated in FIG. 10, or by using a conventional wireless cellular modem connection; or

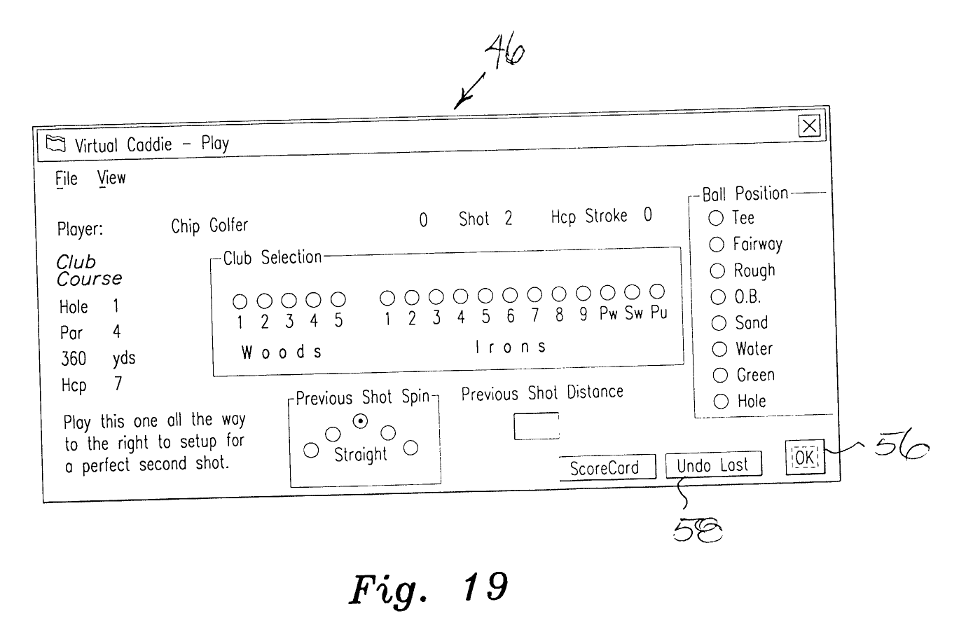

2. indirectly by connecting the hand-held computer 12 to an internet website using a desk top personal computer (PC) 64 and receiver cradle 24, as illustrated in FIG. 11.

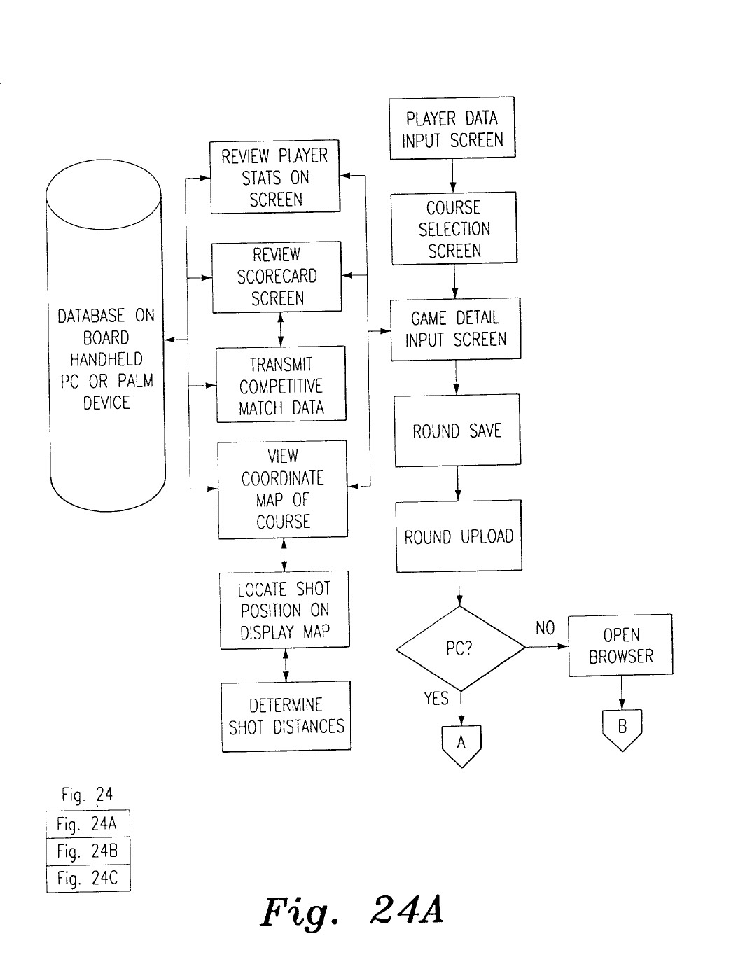

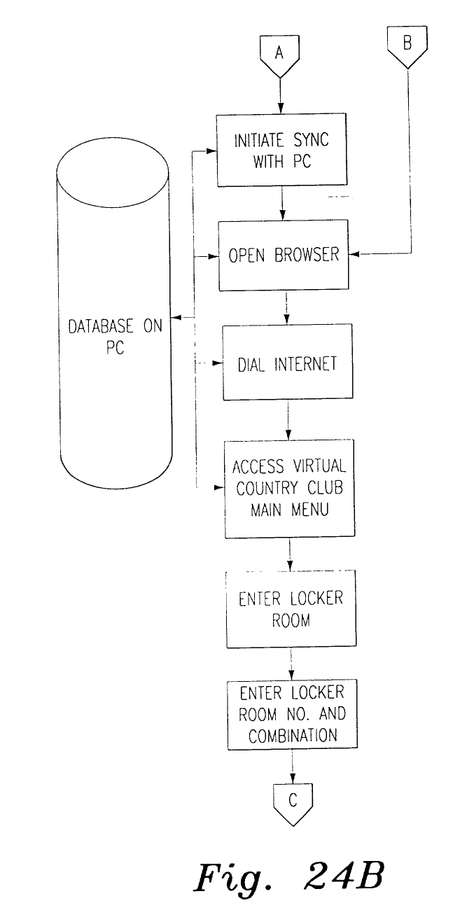

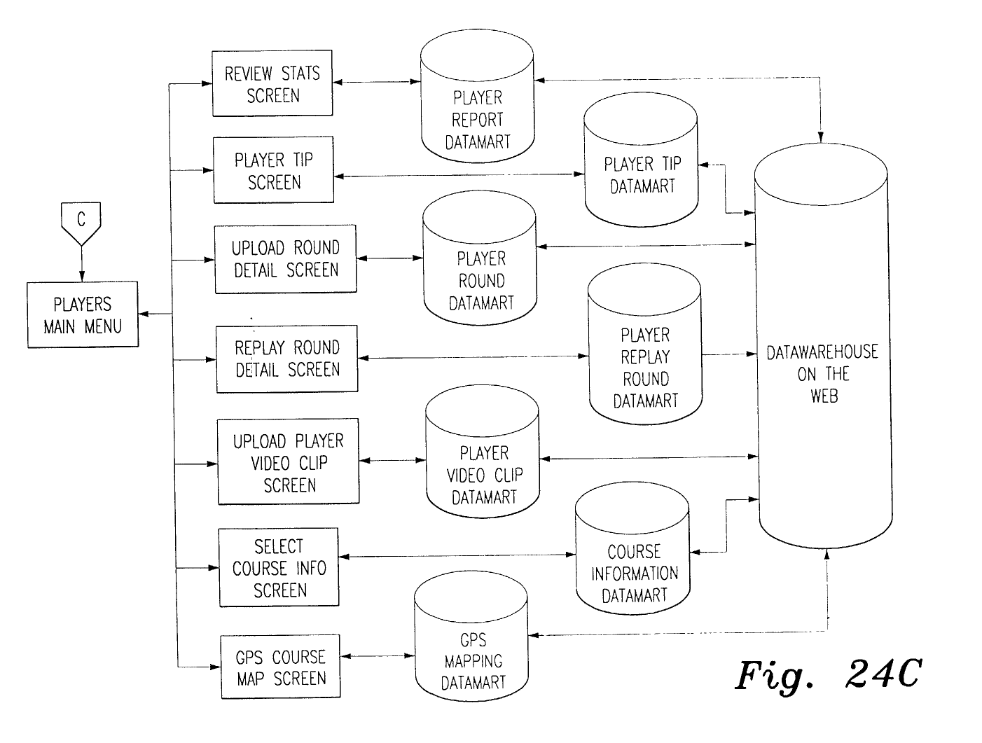

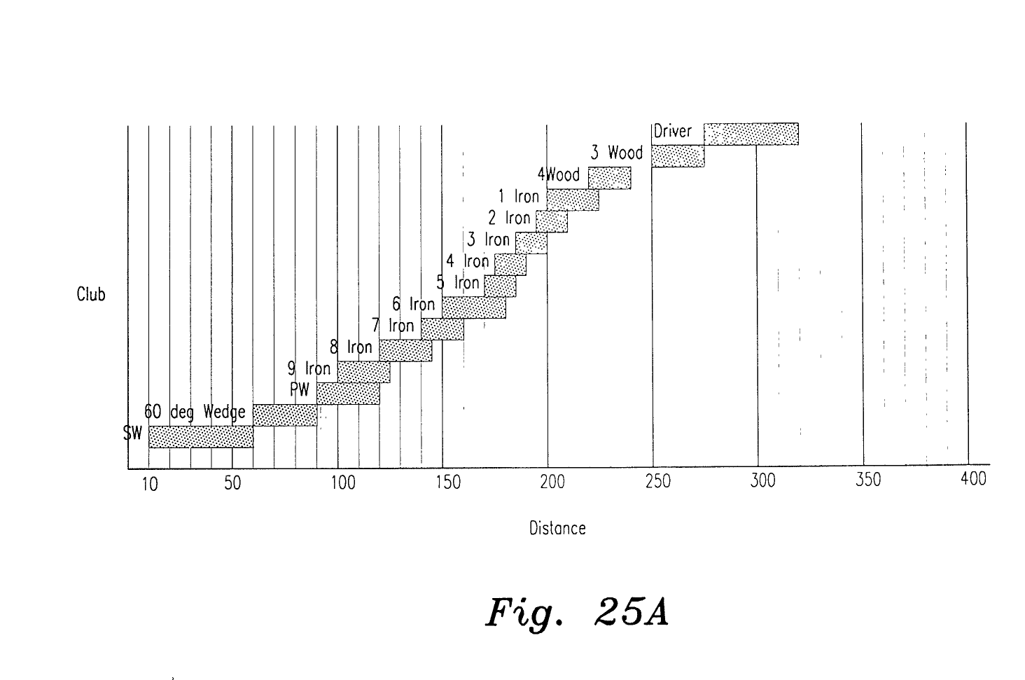

When one of the aforementioned two methods has been selected, the golf program will preferably launch a default browser and initiate the virtual golf country club program. Once a main menu appears, the golfer may select a Locker Room Entrance and input a locker number and combination, as illustrated by the flow chart in FIG. 24. The inputted information is verified against a member database and a selection of services is provided if the golfer is accepted. The golfer may then select an “upload round detail” menu option to upload a “round detail” file. Once the file is uploaded, the “round detail” file would immediately update the data warehouse 66 and the appropriate data marts 68. Thereafter, the golfer may chose from any one of the following services:

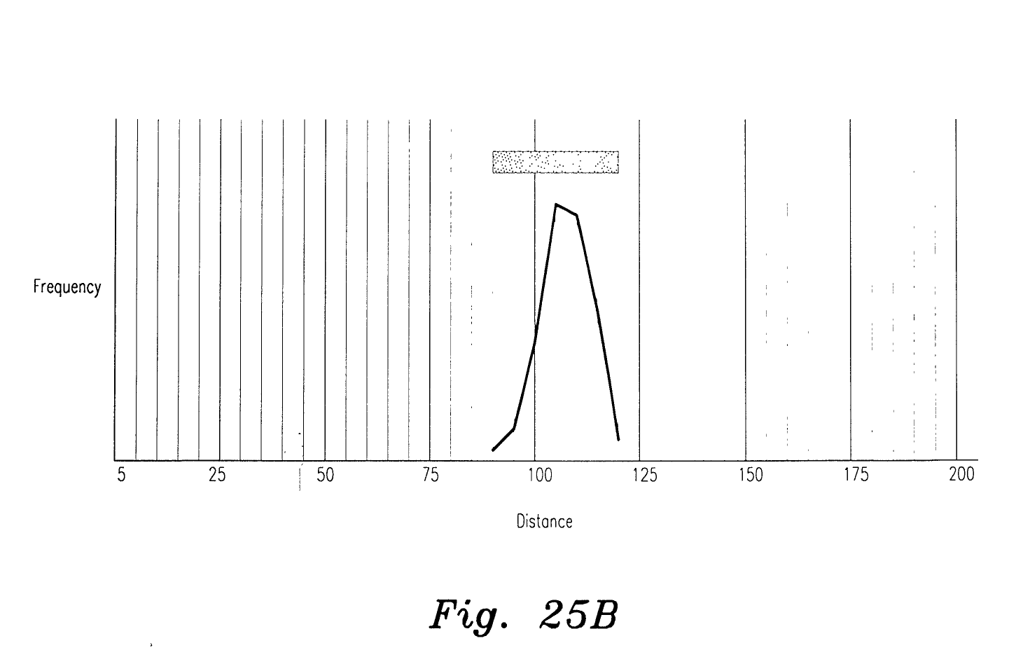

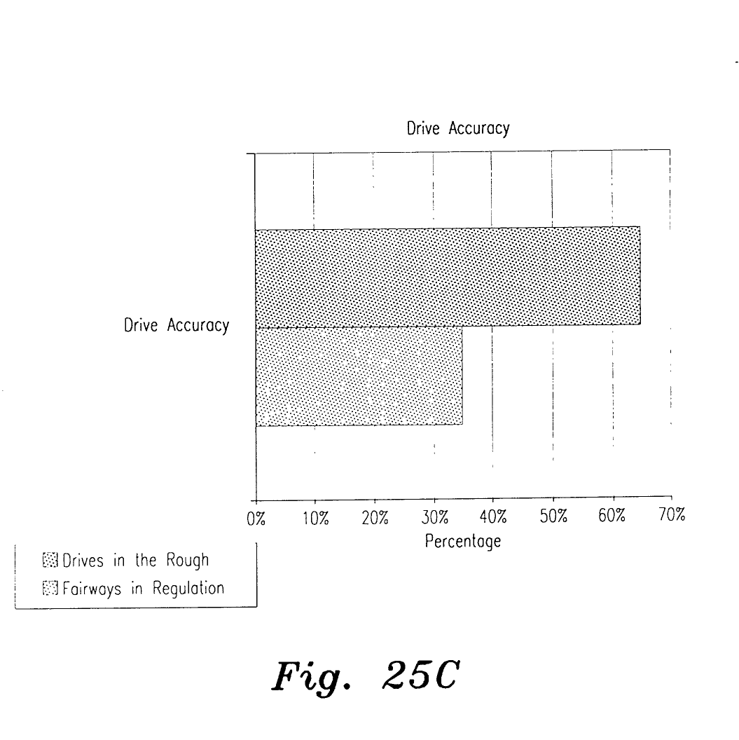

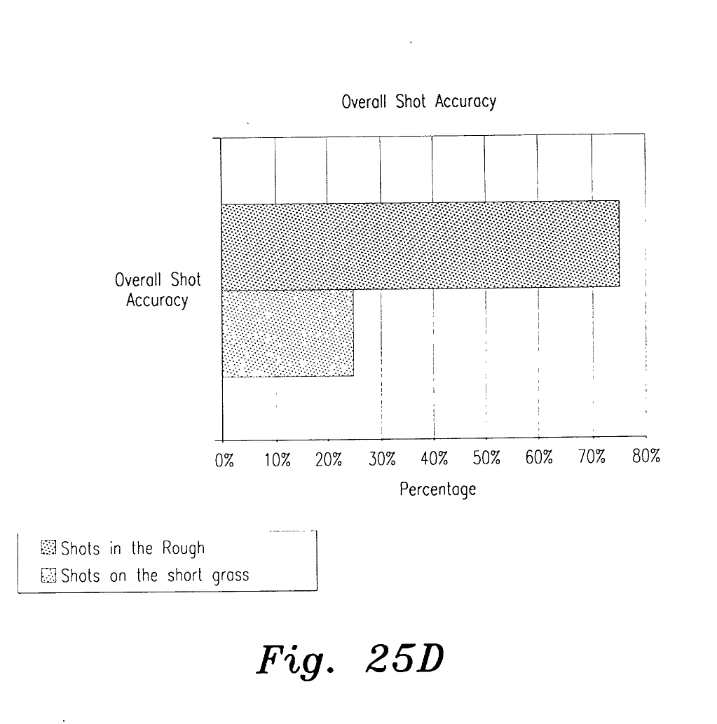

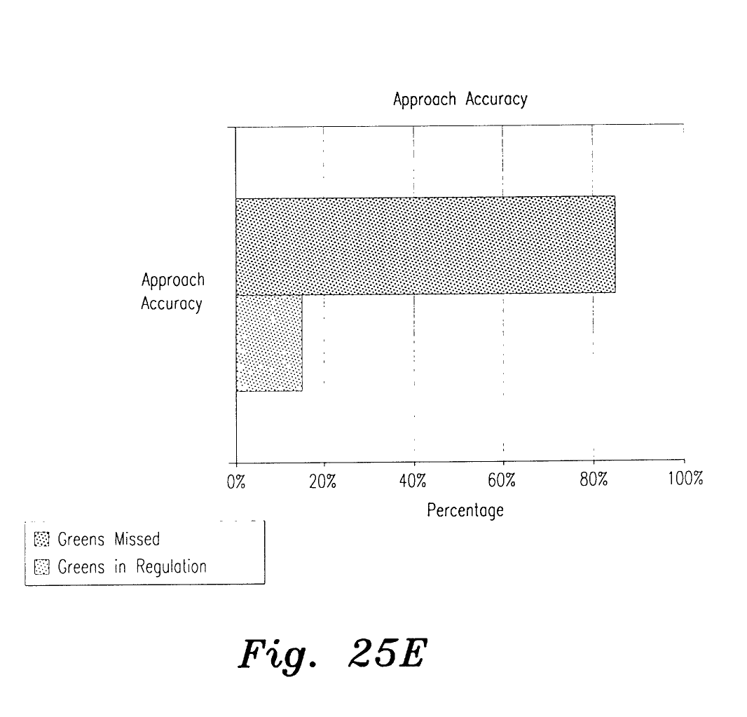

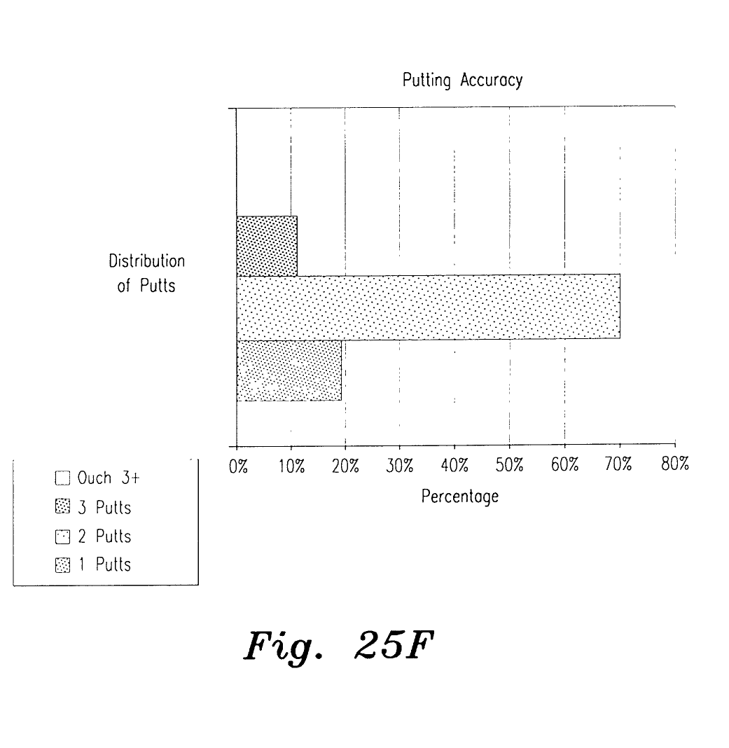

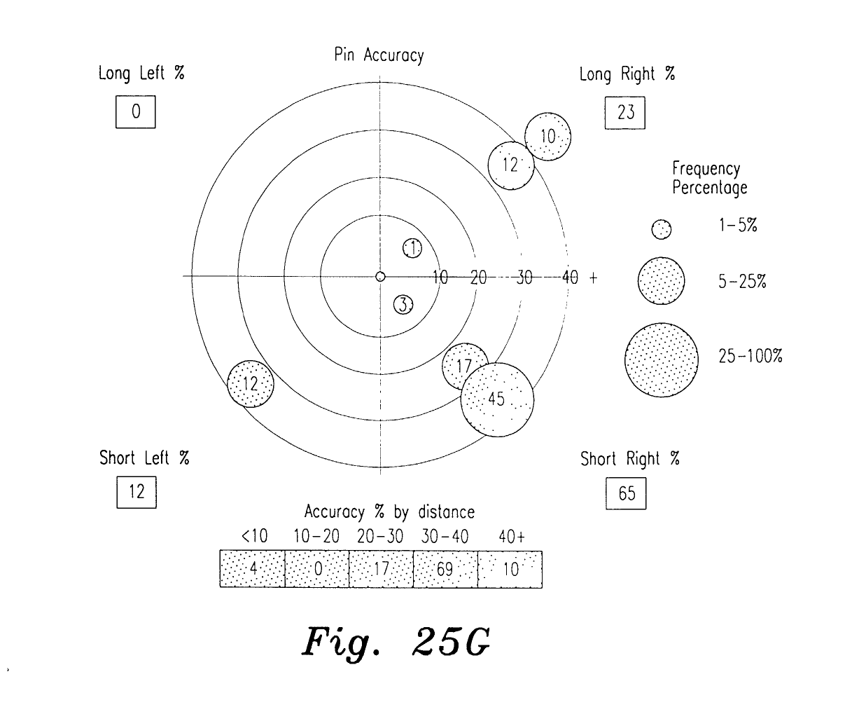

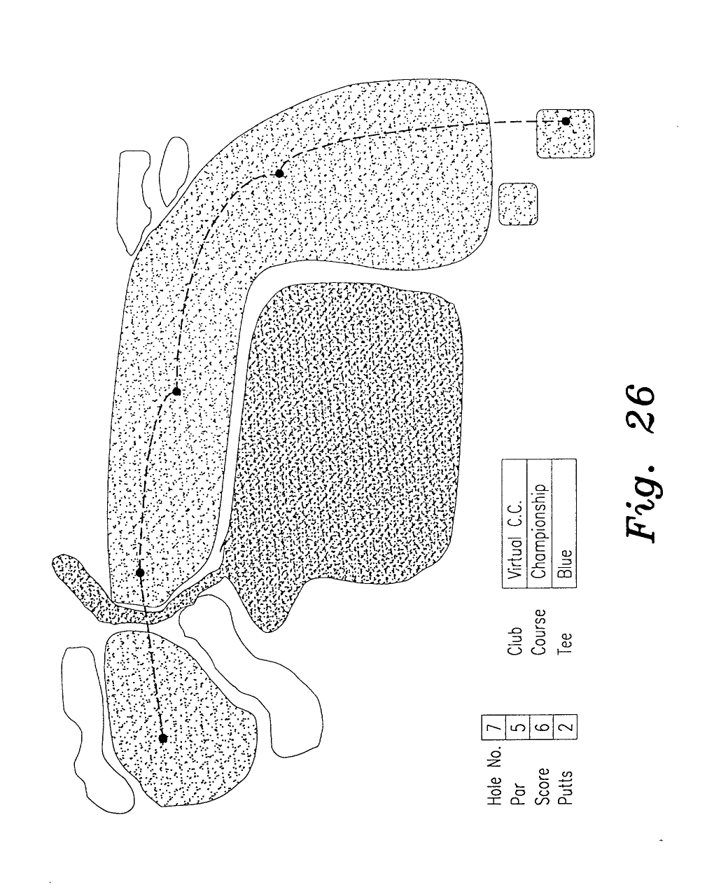

Review Stats windows (FIGS. 25A-G): choose from textual or graphical display of various stats including: average club distance, club range of distances, percentage in rough, percentage of greens in regulation, pin accuracy scattergram, average putts per round, average putts per hole, frequency distribution of putts (e.g., one putt, two putts, etc.).

Review Player Tips window: a club professional will preferably review a member's stats and videos clips if available and provide tips on particular aspects of a member's game the member should work on and how to improve.

Replay Round Detail window: a member can select a completed round of golf to replay. The portable information system 10 utilizes GPS data for a particular member, collected from a golf round, and sequentially animates the shots over a geocoded bitmap course graphic. The member can pause a round at anytime.

Upload Player video clip window: a member can upload video clips in a variety of formats to their “Locker” for review by a club professional.

Select Course Info window: a member can select from all available course detail files. These files include information such as course location, course descriptions, number of courses, hole and tee detail (e.g., yardage, par, handicap, hole tip, etc.), telephone number, etc. GPS course map window: a member can download GPS coordinate maps of all available golf courses. The program uses these maps with the receiver cradle 24 to show a real-time position of the golfer. Without the receiver cradle 24, the golf program uses coordinate maps to capture the approximate GPS coordinate position of a golf ball.

When the golfer is through, he or she may leave the locker room and make use of other available services of the virtual club including a Pro-Shop and a tee reservation service and links to other golf site of interest.

It is to be understood that the present invention is not limited to the sole embodiments described above, but encompasses any and all embodiments within the scope of the following claims.

We claim:

1. A portable information system for golf, comprising:
a hand-held computer for providing a portable computer processing means to be carried by a golfer while playing a game of golf, said hand-held computer having programmed therein a first software program for providing a virtual caddie to provide information regarding a particular golf course and a particular player's golf game, to track player performances, and to communicate a player's competitive match detail to other players, said hand-held computer also having a systemic means for providing a golfer a means to review and evaluate said golfer's golf performance;
a receiver means selectively connected communicatively to said hand-held computer for enabling said hand-held computer to receive GPS and DGPS coordinate positions corresponding to a location on a golf course; and
a user interface communicatively connected to said portable for enabling the golfer to interact with said hand-held computer

2. The portable information system recited in claim 1, wherein said user interface is a keyboard communicatively connected to said hand-held computer.

3. The portable information system recited in claim 1, wherein said held-held computer has a keypad for enabling a golfer to interact with any one of said first software program and said second software program.

4. The portable information system recited in claim 3, wherein said user interface is said keypad.

5. The portable information system recited in claim 1, wherein said user interface is a touch screen.

6. The portable information system recited in claim 1, wherein said user interface is a voice recognition interface for enabling a player to use voice commands to initiate various functions of said first software program.
